(19) United States
(12) Patent Application Publication
(10) Pub. No.: US 2009/0098500 A1
(43) Pub. Date: Apr. 16, 2009

(54) ORTHODONTIC APPARATUS AND DEVICE

(76) Inventor: Juan Carlos Diaz Rendon, Mataro(Barcelona) (ES)

Correspondence Address: DARBY & DARBY P.C., P.O. BOX 770, Church Street Station, New York, NY, 10008-0770, US

(21) Appl. No.: 12/299,763

(22) PCT Filed: Mar. 13, 2007
(86) PCT No.: PCT/ES07/00133

§ 371 Date: Nov. 5, 2008

(30) Foreign Application Priority Data
May 5, 2006 (ES) 200601150
Oct. 20, 2006 (ES) 200602674

(51) Int. Cl. A61C 7/00; A61C 7/08

(52) U.S. Cl. 433/6; 433/18

(57) ABSTRACT

An orthodontic apparatus of the type which comprises a dental cover or ferule, characterized in that, in addition to the dental cover, it comprises an elongate element made of flexible material, fixed by one of its ends to the cover, another end of it being free.

### CROSS REFERENCE TO RELATED APPLICATIONS

The present application is a U.S. National Phase of International Patent Application Serial No. PCT/ES2007/000133, filed Mar. 13, 2007, which claims the benefit of Spanish Patent Application Serial No. 200601150, filed May 5, 2006, and Spanish Patent Application Serial No. 200602674, filed Oct. 20, 2006, all of which are hereby incorporated by reference in their entireties.

### DESCRIPTION

The present invention refers to an orthodontic apparatus and to orthodontic devices which comprise said apparatus.

In particular, the present invention refers to apparatuses and devices which permit the aesthetic correction of the external appearance of a dentition, it being possible to obtain in certain cases the stimulation of the maxillary bone growth which uses such a device.

Orthodontics concerns the modification of the position of the teeth within the mouth. As a consequence of the present aesthetic trends, said branch of the technology is currently centred for the major part on the aesthetic modification of the dentition of its clients, in general for an aesthetic purpose, not a therapeutic one.

In view of the marked aesthetic nature of the majority of orthodontic methods, it is necessary not only to obtain good final results, but in addition, that the devices used are not visible from the outside.

The traditional methods comprise the application of orthodontic apparatuses the function of which is to push the teeth towards the desired position. Said apparatuses are visible from the outside, impede speech and require care and special hygiene on the part of the patient. In addition, in the event that large movements are required, it becomes necessary to eliminate material from the teeth in order to obtain the final result, so that they do not provide sufficient stimulation of bone growth, which generates new spaces for the teeth. In addition, the contact between hard elements in order to generate concrete fixing points with the teeth (brackets) may lead to damaging the tooth enamel. On the other hand, these orthodontic apparatuses and methods take up considerable space within the mouth, so that they are also troublesome for the user.

Transparent covers or ferules made of a plastics material, having resilient properties, have also become known, which are placed so as to cover the teeth and the function of which is to push the teeth towards the desired position. Every so often, the movement which the ferule imparts to the teeth causes it to lose its pressure function and it has to be changed for another different one which again presses the teeth towards the desired position. This method is expensive, in that it requires the production of a complete simulation of the intermediate positions of the teeth during the movement of the entire dentition before producing the covers, making a considerable number of covers for various intermediate states of the dental movement and, in addition, requires frequent visits to the orthodontist to check the movement of the teeth and to change the covers. This method and these devices, in addition, do not stimulate bone growth, so that their results remain limited.

In order to provide a solution to the above-mentioned drawbacks, the present invention discloses an apparatus, and devices which include said apparatus. The apparatus and the devices are easy to manufacture, and are therefore economic. They take up a reduced space in the vicinity of the teeth and do not cause any difficulties with the user's speech. In the tests carried out by the present inventor, the orthodontic devices of the present invention have obtained rapid and excellent results, clearly superior to those of the currently known methods. In addition, the device, once fitted to a user, is not visible from the outside.

In particular, the orthodontic apparatus of the present invention comprises a dental ferule or cover, preferably transparent, to which is fixed an elongate element made of flexible material which is fixed to the ferule by one of its ends, another end remaining free.

In the tests carried out, the advantage of this basic apparatus is its flexibility, so it can be used for producing various orthodontic and orthopaedic devices. This is due to different advantages which the devices produced from the apparatus present. First, they are easily removable by the user, who can take them out only for precise tasks such as eating, cleaning the teeth, etc. Second, the transparent cover permits more prolonged use, so that the user does not take it out for aesthetic reasons at certain moments in the day. These two features mean that the device can act on the user for a more prolonged period.

In addition, the use of anatomical ferules permits the correct transmission of forces and anchorages, making it possible to act on imbalances of forces in the mouth of the patient without causing others to be created. Thus, the versatility of the apparatus makes it possible to adjust the force of the apparatus and for the application of forces to be that required by the circumstances.

Finally, the apparatus of the present invention makes it possible to generate forces which act on the tensional equilibrium existing in the mouth of the user, promoting the strengthening and/or growth of elements (muscles in which the force is “unbalanced” in comparison with the rest of the system) by means of the application of forces in a direction opposed to the “unbalancing” tensions existing in the system, and without thereby causing new imbalances (for example, by the concentration of reaction forces at a point which is not unbalanced or by generating moments of force or reactions due to application remote from the tensioned zone).

As the tests and studies carried out by the inventor have demonstrated, it is precisely by acting against the tensions existing in the system, at the site where they appear, (which may be obtained by means of the apparatus and devices of the present invention) that clearly advantageous results are obtained compared with previously known techniques. This is due to the fact that dental defects (malocclusions, open bite, etc.) have their origin in a high percentage of cases in an imbalance existing in the muscular mechanisms of the mouth (peribucal musculature, elevator muscles, depressor muscles), which act as a whole with the dental and bone system.

The elongate element or arch may preferably be a wire-like element, made of metallic material such as stainless steel, for example. Preferably, it may have a curved shape which corresponds to a jawbone, such that the elongate element will pass close to the wall of a set of teeth, but preferably the inner or hidden face of the teeth. In another preferred embodiment, the wire-like elongate element will have a curved portion at one end which defines a return of part of the wire-like element towards the cover. A cover may have more than one elongate element.

The elongate element or arch fixed to the cover, according to the present invention, may perform active functions (pressure against gum and/or teeth) or passive functions of joining or transmission of stresses towards the cover, for which reason the apparatus of the present invention is very versatile and makes it possible to produce numerous devices which are also the subject of the present invention. As stated, this arch or elongate element has the advantage of not interfering with the movements of the tongue by passing in the zone immediately adjacent to the inner face of the teeth.

The cover will preferably cover several teeth and will be used to distribute uniformly the stresses due to actions exerted on teeth not covered by the cover.

Other elements may also be fixed to the cover, such as an element for fixing a resilient band to the cover, for example a hook.

Finally, the apparatus of the present invention constitutes a base on which are constructed devices of the present invention, which they comprise. By means of different combinations, different devices are produced having different functions, such as centering, distancing, etc. The apparatus of the present invention likewise has the advantage that it is easy to construct. In general, the purpose of the cover is to ensure a well-distributed support, non-injurious and, in its case, not harmful to the active elements which are connected to it. The elongate element itself, depending on the arrangement in which it is used, may perform active functions, by exerting pressure on teeth, or passive functions, by transmitting the fixing of the active elements to the cover or by fixing said active elements.

According to a first aspect, a device which utilises the apparatus of the present invention may include at least two dental covers, each cover having at least one elongate element made of flexible material, each of the elongate elements being fixed by one of its ends to its corresponding ferule, another end of it being free, and may also include a spring for joining the elongate elements to each other via their free ends.

That is to say, a device of the present invention may comprise two orthodontic apparatuses of the present invention and a spring for joining both. Naturally, preferred embodiments of the device of the present invention will correspond to preferred embodiments of the apparatus which have been mentioned previously.

In preferred embodiments, the free ends of the elongate elements or arches are disposed opposite each other, in the zone located between the covers. In specific preferred embodiments, in which at least one elongate element or arch performs active tasks, it will come into contact with a tooth in the vicinity of its fulcrum, putting pressure on it and in this way obtaining the displacement of the tooth without rotation of the latter. Preferably, the arches or elongate elements will pass by the rear face of the teeth, becoming invisible from the outside, but collaborating in the movement of the teeth and/or in the bone growth. Advantageously, the elongate elements of the device of the present invention may be disposed in a zone immediately adjacent to the teeth, such that the device does not occupy the central region of the mouth.

The joining spring may likewise have a principally passive function of transmitting stresses, or an active function, by curving it in such a way that it exerts a force which facilitates the opening and bone growth of the jaws, performing the functions of an activator of the elongate elements. This force may be additional to that which an elongate element, by itself, produces. The joining spring, or another specific spring, may also be disposed in compression between two covers, such that it tends to separate them, and also in the stretched state, in such a way that it tends to bring the covers closer together, which may be useful in the case of centering and distancing.

For another type of orthodontic operations, resilient bands may be fixed to the covers, for example by means of hooks fixed to the cover for such a purpose.

According to another aspect of the present improvements, these include an orthodontic device which itself includes three dental covers corresponding to the same row of teeth, one dental cover being displaced with respect to the arrangement of the teeth to which the covers correspond, the device also having respective elongate elements made of flexible material, fixed by respective ends to the undisplaced covers for joining with the displaced cover, such that, once placed in the mouth, the elongate elements exert a resilient force on the displaced cover.

The remaining or “free” ends of the elongate elements may be joined to the displaced ferule in different ways, for example by providing anchorage zones for the free ends, by adhesive means or in some other way.

This device is especially effective in the generation of spaces as a step prior to the carrying out of other operations, permitting, for example, the displacement of a group of teeth with respect to others, but without increasing the distance existing between the teeth of each of the groups.

According to yet another aspect, the present invention relates to an orthodontic device which includes a dental cover which has an elongate element made of flexible material, said elongate element being fixed by one of its ends to the cover, the other end of it being free and the elongate element having an angular spring, and another dental cover which has an anchorage point for the free end of the elongate element.

The angular spring may consist of at least one circular loop of the elongate element. In order to facilitate anchorage to the other cover, the free end of the elongate element may be in the shape of a hook.

According to yet another aspect, the present invention relates to a device which includes at least two dental covers, each cover having at least one elongate element made of flexible material, each of the elongate elements being fixed by one of its ends to its corresponding ferule in a zone corresponding to the inside of the teeth, the other end of it being free, and each cover having in addition an anchorage point for a resilient rubber band disposed in a zone corresponding to the outer part of the teeth covered by the cover, and a resilient rubber band having a length sufficient to pass, in the tensioned state, over the outer part of an undisplaced tooth not covered by either of the two aforesaid ferules and the inner part of a displaced tooth not covered by either of the two aforesaid ferules. Preferably, the aforesaid free ends will be joined to each other by a spring.

This device is clearly advantageous because it allows the resilient rubber band to balance the force produced by the elongate element on the undisplaced teeth at the same time as it adds an additional effect which promotes the movement of the displaced teeth. In addition, on passing from the outside of an undisplaced tooth to the inside of a displaced tooth, the rubber band exerts an effect which tends to separate the undisplaced tooth from the path of relocation of the displaced tooth. That is to say, the device exerts forces opposed to the existing tensions and applied at the site of the appearance of said tensions.

Furthermore, the elongate elements have a shape such that, when they are placed in the mouth of the user they exert a resilient force on the user of between 20 and 26 grams force. Surprisingly, according to the tests carried out, and although values outside said range are possible, significantly greater forces do not necessarily bring about more rapid or better results, while significantly smaller forces are significantly less efficient. Without wishing to bind this invention to any theory, the present inventor believes that it is due to the fact that the force exerted must be of the order of the internal tension existing in the tissues, greater forces not being transmitted efficiently by said tissues.

The devices of the present invention exhibit the following advantages compared with the prior art:
they are easily made invisible,
they are easy to fit,
they are easy to manufacture,
they are hygienic and do not impede speech,
they last a long time, not requiring the user to make constant visits to the orthodontist.

In addition, the tests carried out by the inventor give as a result a better response than the other known invisible systems. In particular, the present device is capable of achieving significant stimulation of the bone growth, it being unnecessary to file the teeth in order to obtain the desired aesthetic effect.

In addition, the apparatus of the present invention may easily be configured in different devices in order to carry out a wide variety of orthodontic operations.

For greater understanding of the invention, drawings of some embodiments of the present invention are appended by way of non-limiting example.

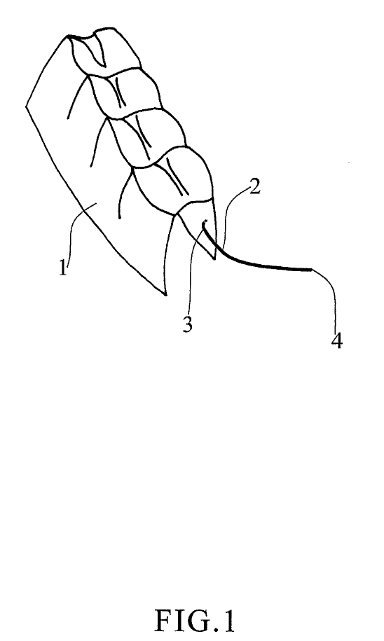

FIG. 1 is a perspective view of an apparatus according to the present invention.

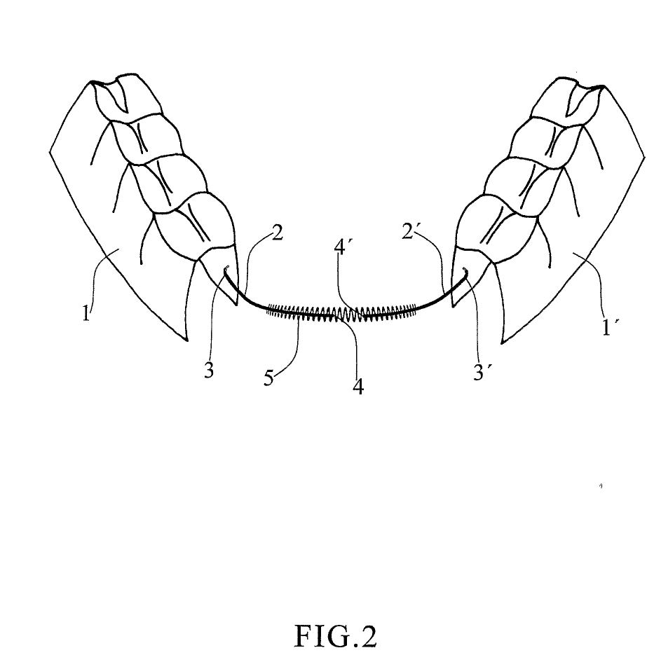

FIG. 2 is a perspective view of a device according to the present invention.

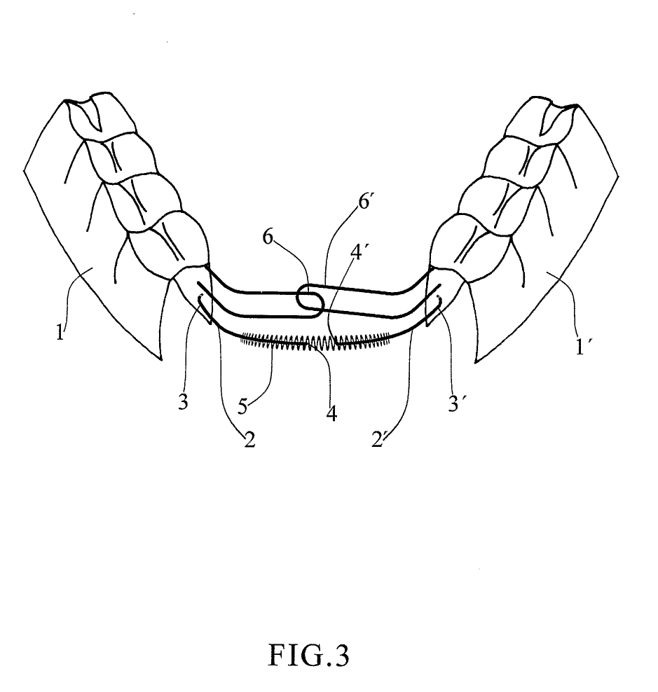

FIG. 3 is a perspective view of another device according to the present invention.

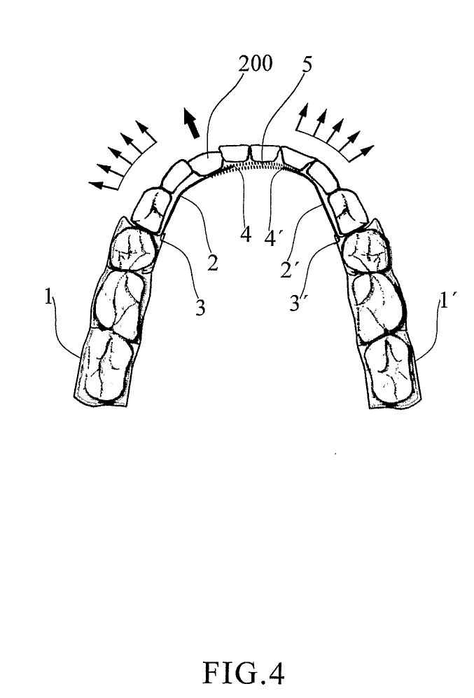

FIG. 4 shows a diagram of application of a device similar to that shown in FIG. 2.

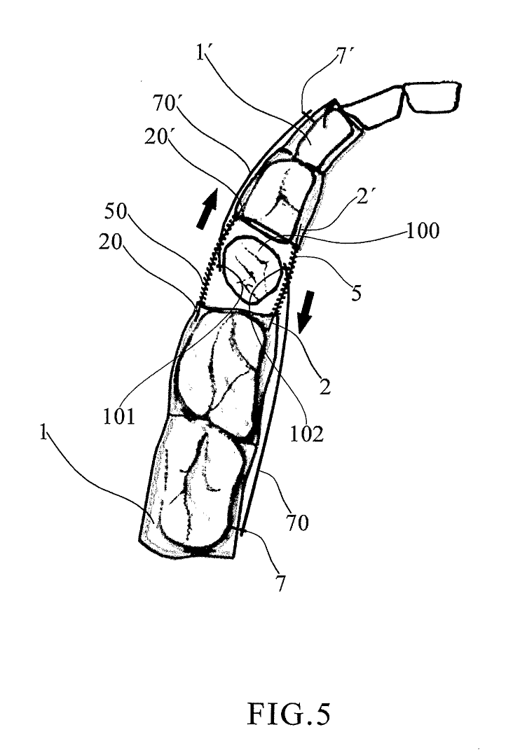

FIG. 5 is another diagram of application of another different device of the present invention.

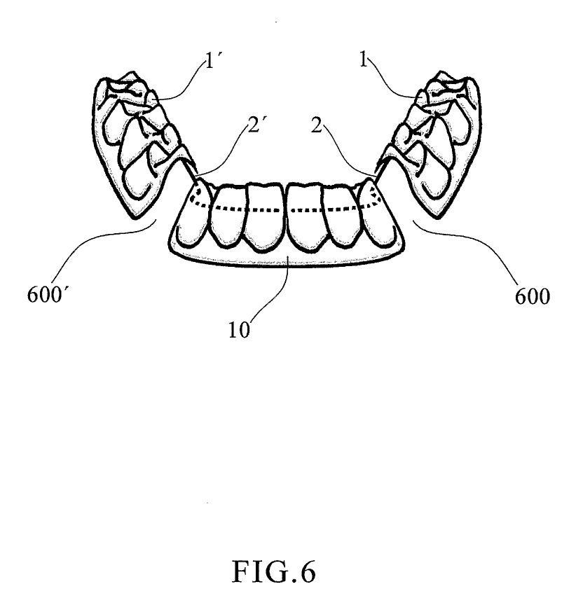

FIG. 6 is a perspective view of another device according to the present invention.

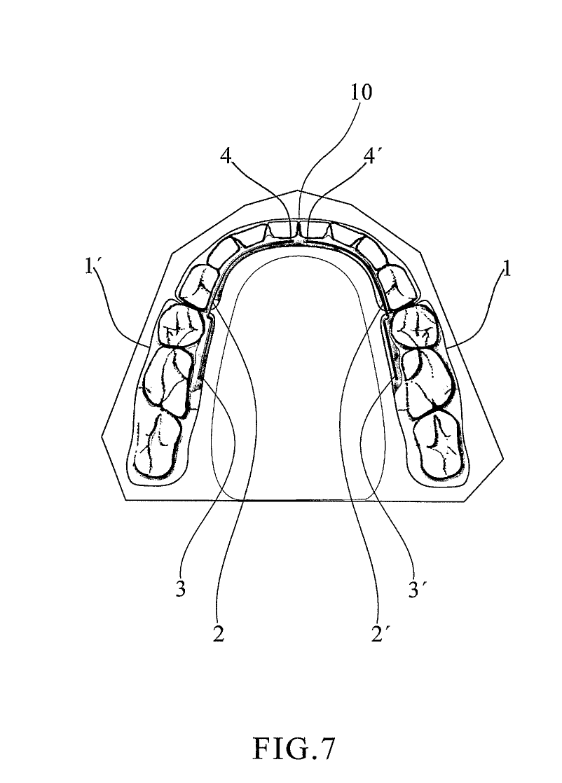

FIG. 7 is a diagrammatic view of a set of teeth in which a device according to FIG. 6 has been placed.

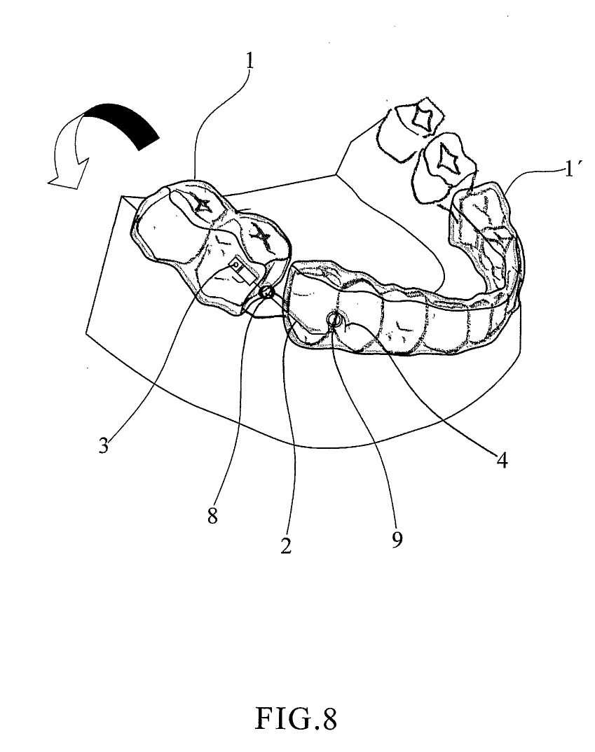

FIG. 8 is a perspective view of another device according to the present invention, in the operative position.

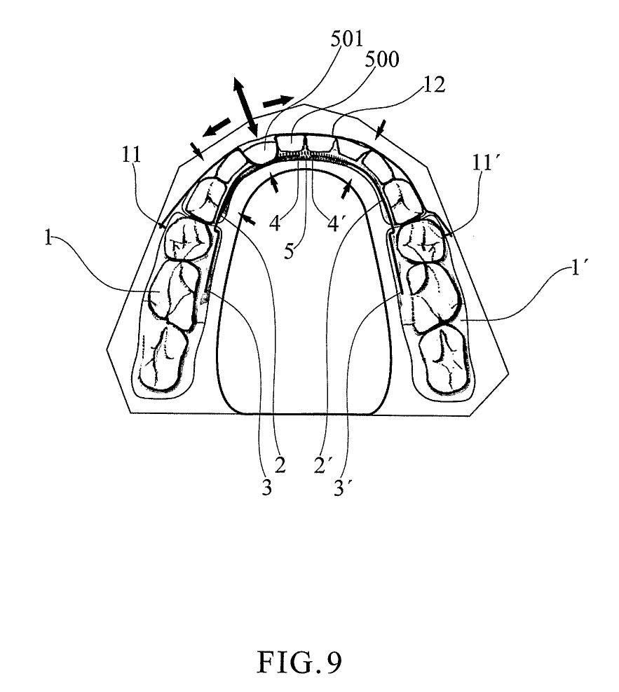

FIG. 9 is a diagrammatic view of another device according to the present invention, also in the operative position.

FIG. 1 shows an apparatus of the present invention composed of a dental cover 1, made according to the measurements of a client or user, and an elongate element or arch 2 joined by one of its ends 3 to the cover 1, and another 4 of its ends being free. The covers are preferably made of a transparent plastics material, such as polycarbonate. The elongate element 2 may be formed by a stainless steel wire, for example 0.7 mm in diameter. The method of joining between the cover 1 and the elongate element 2 may be by acrylic adhesive means. Finally, the apparatus of the present invention is economic and easy to manufacture, since any orthodontist can prepare it in his laboratory workshop. Although it has not been shown in the drawings, it will also be possible to fix to the cover at least one hook, preferably external, made of stainless steel, for example with bends at the ends, in order to fix it to the cover or ferule with acrylic and which will serve to hook intra- and intermaxillary resilient bands. For this purpose tubes and protuberances for anchorage may be added to the cover.

FIG. 2 shows a possible embodiment of the device of the present invention, which is formed by two apparatuses 1, 1′, 2, 2′ etc., similar to what is shown in FIG. 1, joined to each other by means of a spring 5, which joins both elongate elements 2, 2′, which are disposed opposite each other, in the zone between covers 1, 1′. The spring may be a spring made of a commercially available nickel/titanium alloy. In the case shown, the spring 5 is slightly curved, so that it produces a force separating the covers 1, 1′ from each other. Preferably, the elongate elements 2, 2′ will be arched in order to extend in the zone closest to the inner face of the dentition via its palate or tongue region, that is to say, the curved shape of the elongate element corresponds in these zones to the corresponding jawbone.

Although it has not been shown in the drawings, the elongate elements or arches may have vestibularisation hooks which also will join to the joining spring 5.

FIG. 3 shows another embodiment of the device of the present invention. In this, the wire-like elements which form the elongate elements 2, 2′ have, in addition to the free end 4, 4′, a curved zone 6, 6′ which defines a return of the wire-like element 2, 2′ towards the cover 1, 1′. In this way it is possible to generate points of contact and pressure between a specific tooth or teeth and these return zones of the elongate elements 2, 2′, above or below the palate region or tongue region. In general, it is of advantage to be able to exert the forces on the tooth by pressing on it in the vicinity of its fulcrum, in such a way as to obtain displacements without producing unwanted rotation. As will be observed in the drawings, the spring 5 may exert an action on the teeth which is additional to that exerted by the elongate element 2, 2′.

The manufacture of a device according to the present invention is advantageously simple. First, transparent ferules for the upper set of teeth, or for the lower, or both, are prepared as required. Then, with the steel wire, the upper and lower, right and left elongate joining elements or arches are prepared, also as required. Afterwards the distal end of each of the joining arches is adhesively secured by means of acrylic at the palate or tongue region of the corresponding zone (for example the canine zone) of each transparent ferule. The ferules are shortened and polished according to the needs of each particular case. The nickel-titanium joining spring is added within the joining arches and then the placing in the dentition of the patient is carried out.

In FIG. 4 can be seen an example of application of a device of the present invention to a set of teeth. The elements similar to those shown in FIGS. 1 to 3 have been designated by identical numerals. It will be observed that when the arches 2, 2′ are disposed in the zone immediately adjacent to the inner face of the teeth, the device leaves the central region of the mouth free, thus constituting one of the advantages of the devices of the present invention. In the drawing, some of the forces exerted on the teeth by the device have been shown by means of arrows.

FIG. 5 shows a different application. The targeted purpose in this case is to rotate a tooth 100. For this a series of additions to a device similar to that shown in the previous figures have been used. It will be observed in this case that each cover 1, 1′ has two arches or elongate elements 2, 20, 2′, 20′ joined by the corresponding springs 5, 5′. On the other hand, there have been joined to the tooth to be rotated 100, anchorage protuberances 101 to which have been fixed resilient bands 70, 70′ fixed to the covers or ferules 1, 1′ via joining means such as hooks 7, 7′. The resilient bands will preferably be transparent. In specific cases, the function of the resilient bands may also be performed by other resilient elements such as metal hooks.

FIGS. 6 and 7 show an example of an orthodontic device obtainable starting from the apparatus of the present invention, thereby sharing with it the same inventive concept.

The device shown in FIGS. 6 and 7 is composed of two apparatuses according to the present invention, between which a third cover has been placed in an intermediate position. More particularly, the device of FIGS. 6 and 7 comprises three transparent dental covers 1, 10, 1′. Said three covers, in the example shown, may be obtained, for example, by producing a cover corresponding to all the teeth from a mould corresponding to the mouth of the patient. Said cover is then divided into three pieces, giving rise to the covers 1, 10′, 1′, which will be joined by means of wire-like elongate elements 2, 2′ which pass through separating spaces between covers 600, 600′. On joining the covers to one another, the cover 10 corresponding to the front teeth has been placed in a displaced position with respect to the actual situation of the teeth. In this way, once the device is placed in the mouth of the patient, the wires produce a resilient force by deformation which acts on the front teeth by way of the cover. The joining of the wire-like elements 2, 2′ to the rear covers 1, 1 may preferably be effected by means of adhesive securing of their corresponding ends 3, 3′. The joining of the free ends 4, 4′ of the wire-like elements to the front cover 10 may be effected by any means, for example by arranging reception zones in the front cover 10 or by some other method. It would also be possible to join the wire-like elements 4, 4′ to each other as well as to the front cover 10. For a better resilient action, the wire-like elements 2, 2′ may have changes of direction between covers.

FIG. 8 shows another exemplary embodiment of a device according to the present invention. In this case it is necessary not only to displace teeth, but also to impart to them a rotation with respect to the rest of the teeth. The device is formed by a transparent rear cover 1 equipped with a wire-like elongate element 2 which has an angular spring region formed by circular loops 8 along its course. The wire-like element 2 is joined to the rear cover 1 via a joining point 3 which allows the element a certain rotation. The free end 4 of the wire-like element has a hook 4 for joining to a receiving element 9 joined to a second transparent cover 1′ which covers a plurality of teeth. This makes it possible to distribute the appropriate actions over the teeth with an anatomical load distribution which allows the body to activate the self-responsive body mechanisms producing for themselves a new balance in the system which permits the displacement of the teeth.

Lastly, in FIG. 9 yet another embodiment according to the present invention has been shown, illustrating its great versatility. In this case, this device takes as a base two aforesaid apparatuses according to the main patent, which are joined by way of a helical spring 5 by the free ends 4, 4′ of the elongate elements 2, 2′ of each of its apparatuses, the course of said wire-like elements 2, 2′ passing by the inner part of the teeth. Starting from this arrangement, the device is completed by two fixing zones 11, 11′ for a resilient band 12 which are located in the region corresponding to the outside of the teeth. The resilient band 12 passes over the teeth not covered by the covers 1, 1′ in such a way as to ensure that the expanding movement of the teeth caused by the device does not result in their separation. However, the resilient band 12 passes over the inner part of the occluded tooth 501 in such a way that the band “pushes” the tooth towards the desired position, but, in addition, tends to open the space existing between the adjacent teeth by means of a force which acts precisely in this situation.

The preceding description refers to some arrangements which can be obtained through the apparatus of the present invention. A person skilled in the art will however rapidly perceive that there are various possibilities for variation and combination of what has been shown in order to obtain the desired effects without departing from the present invention. Thus, for example, in edentate areas it will be possible to arrange a joining spring 5 in an open or closed position, such that it tends to join or separate the ferules and with them the teeth, so that the desired distancing or centering is obtained. It will also be possible to arrange resilient means, preferably transparent, which pass over the incising zone towards its outside and which are fixed to the fixing means of the corresponding ferules which they join. Especially in this case, if there is an over-bite, it is recommended that an acrylic bite plane be placed.

1. An orthodontic apparatus of the type which comprises a dental cover or ferule, wherein, in addition to the dental cover, it comprises an elongate element made of flexible material, fixed by one of its ends to the cover, another end of it being free.

2. The orthodontic apparatus of claim 1, wherein the dental cover is made of transparent material.

3. The orthodontic apparatus of claim 1, wherein the elongate element comprises a wire-like element.

4. The orthodontic apparatus of claim 1, wherein the elongate element is made of a metallic material.

5. The orthodontic apparatus of claim 1, wherein the cover comprises at least one element for fixing a resilient band to the cover.

6. The orthodontic apparatus of claim 5, wherein said fixing element is a hook.

7. The orthodontic apparatus of claim 1, wherein the elongate element has a curved shape, said curved shape corresponding to a jawbone.

8. The orthodontic apparatus of claim 3, wherein the wire-like element has a curved portion at one end which defines the return of the wire-like element towards the cover.

9. An orthodontic device, comprising:
at least two dental covers, each cover having at least one elongate element made of flexible material, each of the elongate elements being fixed by one of its ends to its corresponding ferule, another end of it being free, and
a spring for joining the elongate elements to each other via their free ends.

10. The orthodontic device of claim 9, wherein the covers are transparent.

11. The orthodontic device of claim 9, wherein the elongate element is a wire-like element.

12. The orthodontic device of claim 9, wherein the elongate element is made of a metallic material.

13. The orthodontic device of claim 9, the cover comprises at least one element for fixing a resilient band to the cover.

14. The orthodontic device of claim 13, wherein said fixing element is a hook.

15. The orthodontic device of claim 9, the free ends of the elongate elements are arranged opposite each other, in the zone located between the covers.

16. The orthodontic device of claim 9, wherein at least one of the elongate elements has the function of entering into contact with the rear face of a tooth to be moved.

17. The orthodontic device of claim 16, wherein at least one of the elongate elements enters into contact with a tooth in the vicinity of its fulcrum, exerting pressure on it.

18. The orthodontic device of claim 16, wherein the spring is bent back in such a way that it exerts a force additional to that exerted by the elongate element which has the function of entering into contact with the rear face of the tooth to be moved.

19. The orthodontic device of claim 9, wherein the spring is located in compression between the two covers, such that it exerts a force which tends to separate the covers.

20. The orthodontic device of claim 13, wherein both covers are arranged so that they are joined by a resilient band.

21. The orthodontic device of claim 20, wherein said resilient band is transparent.

22. The orthodontic device of claim 9, wherein the elongate elements are arranged in a zone immediately adjacent to the inner face of the dentition, such that the device leaves the central region of the mouth free.

23. The orthodontic device of claim 9, wherein at least one of the elongate elements has a curved shape, said curved shape corresponding to a jawbone.

24. The orthodontic device of claim 11, wherein the wire-like element has a curved portion at one end which defines a return of the wire-like element towards the cover.

25. An orthodontic device comprising:
three dental covers corresponding to the same row of teeth, one dental cover being displaced with respect to the arrangement of the teeth to which the covers correspond; and
respective elongate elements made of flexible material, fixed by respective ends to the undisplaced covers, for joining to the displaced cover, such that, once placed in the mouth of the user, the elongate elements exert a resilient force on the displaced cover.

26. The orthodontic device of claim 25, wherein the displaced cover has receiving zones for the elongate elements.

27. The orthodontic device of claim 25, wherein the elongate elements have changes of direction between covers.

28. An orthodontic device comprising:
a first dental cover which has an elongate element made of flexible material, said elongate element being fixed by one of its ends to the first cover, the other end of it being free, and the elongate element having an angular spring; and
a second dental cover which has an anchorage point for the free end of the elongate element.

29. The orthodontic device of claim 28, wherein the angular spring consists of a circular loop of the elongate element.

30. The orthodontic device of claim 28, wherein the free end of the elongate element is in the shape of a hook.

31. An orthodontic device comprising at least two dental covers, each cover having at least one elongate element made of flexible material, each of the elongate elements being fixed by one of its ends to its corresponding ferule in a zone corresponding to the inside of the teeth, the other end of it being free, each cover having in addition an anchorage point for a resilient rubber band, disposed in a zone corresponding to the outer part of the teeth covered by the cover, and a resilient rubber band having a length sufficient to pass, in the tensioned state, over the outer part of an undisplaced tooth and the inner part of a displaced tooth which are not covered by either of the two aforesaid ferules.

32. The orthodontic device of claim 31, wherein the free ends of the aforesaid elongate elements are joined to each other by means of a spring.

33. The orthodontic device of claim 9, wherein the device exerts a force of between 20 and 26 grams force on the teeth to be displaced.

34. The orthodontic device of claim 25, wherein the device exerts a force of between 20 and 26 grams force on the teeth to be displaced.

35. The orthodontic device of claim 28, wherein the device exerts a force of between 20 and 26 grams force on the teeth to be displaced.

36. The orthodontic device of claim 31, wherein the device exerts a force of between 20 and 26 grams force on the teeth to be displaced.
